(19) United States
(12) Patent Application Publication
(10) Pub. No.: US 2015/0117922 A1
(43) Pub. Date: Apr. 30, 2015

(54) APPARATUS FOR TREATING MEDIA SHEETS

(71) Applicant: OCE-TECHNOLOGIES B.V., Venlo (NL)

(72) Inventors: Jeroen P.J. HUIJBERS, Waalre (NL); Johannes P.J.C ROOIJAKKERS, Velden (NL)

(73) Assignee: OCE-TECHNOLOGIES B.V., Venlo (NL)

(21) Appl. No.: 14/522,125

(22) Filed: Oct. 23, 2014

(30) Foreign Application Priority Data
Oct. 24, 2013 (EP) 13190119.1

(51) Int. Cl. G03G 15/20

(52) U.S. Cl. CPC G03G 15/2017
USPC 399/341

(57) ABSTRACT

In a combination of an image forming apparatus and an apparatus for treating media sheets after an image has been formed, the image forming apparatus includes a processing stage causing the media sheets to be heated, and the apparatus for treating the media sheets is disposed on a discharge side of the image forming apparatus. The apparatus for treating media sheets includes a perforated conveying and support substrate arranged to convey the media sheets through a stabilization zone where the substrate has a limited curvature. A suction device applies a vacuum to the perforations of the substrate in the stabilization zone so as to suck the media sheets against the substrate. A cooling system is arranged for actively cooling the media sheets while they are sucked against the substrate in the stabilization zone.

### CROSS-REFERENCE TO RELATED APPLICATIONS

This application claims priority under 35 U.S.C. §119(a) to Application No. 13190119.1, filed in Europe on Oct. 24, 2013, the entirety of which is expressly incorporated herein by reference.

### BACKGROUND OF THE INVENTION

1.Field of the Invention

The present invention relates to a system comprising an image forming apparatus and an apparatus for treating media sheets after an image has been formed. The image forming apparatus includes a processing stage causing the media sheets to be heated. The apparatus for treating the media sheets is disposed on a discharge side of the image forming apparatus and includes a perforated conveying and support substrate arranged to convey the media sheets through a stabilization zone where the conveying and support substrate has a limited curvature. A suction device is configured to apply a vacuum to the perforations of the conveying and support substrate in the stabilization zone so as to suck the media sheets against the conveying and support substrate.

2. Background of the Invention

When media sheets such as sheets of paper, machine coated paper sheets or plastic film are processed in an image forming apparatus, for example, in which a liquid ink or toner is applied to one side of the sheets and/or the sheets are subjected to a heat treatment, e.g. for fusing a toner image on the sheets or drying and fixing an ink image on the sheets, the sheets tend to deform after they have been processed. The tendency to deform is particularly pronounced in case of sheets that bear a coating on one side.

U.S. Pat. No. 6,467,410 B1 describes an apparatus of the type indicated above, which may be used for treating the sheets after the image forming process in order to reduce the curls in the sheets. In this apparatus, the deformations are at least partly eliminated by sucking the sheets, by means of vacuum pressure, against a substrate surface that is flat or curved only gently, so that the sheets adopt the flat or gently curved configuration of the substrate.

In conjunction with an image forming process in which the sheets are subjected to a heat treatment, it is known, e.g. from U.S. Application Publication No. 2011/0090279 A1, to pass the heated sheets through a cooling zone where the temperature of the sheets is reduced again, e.g. by blowing cold air against the sheets or contacting them with a cooled substance.

U.S. Application Publication No. 2002/0071016 A1 and JP 2013-049567 A disclose image forming apparatus, wherein a cooling system is provided for cooling a support substrate that supports the media sheets inside of the images forming apparatus where they are exposed to heat, thereby preventing the support substrate from becoming over-heated.

### SUMMARY OF THE INVENTION

It is an object of the present invention to provide an apparatus that reduces the deformation tendency of the sheets more efficiently, especially, when the sheets have been heated in a preceding process.

In order to achieve this object, the system according to the present invention includes a cooling system arranged for actively cooling the media sheets while they are sucked against the substrate in the stabilization zone.

By actively cooling the media sheets while the media sheets are flattened by being sucked against the substrate surface, the flat configuration of the substrate surface is “frozen” in the sheet, so that the deformation tendency is reduced significantly.

In a particularly preferred embodiment, the substrate is an endless conveyer arranged for conveying the sheets from an entry side of the stabilization zone to an exit side, and the cooling system is arranged for cooling the substrate on a return path from the exit side to the entry side. In this case, the heat capacity and heat conductivity of the substrate are used for cooling the sheets indirectly. The heated sheets transfer their heat to the substrate while they are sucked against the substrate in the stabilization zone, and then the temperature of the substrate is returned to ambient temperature or below ambient temperature in the cooling zone. Since the cooling zone is separated from the stabilization zone, the cooling system can act upon the substrate in a state in which the substrate is not covered by the media sheets and the cooling system does not interfere with the vacuum system in the stabilization zone.

In an embodiment, the apparatus according to the present invention comprises a mechanism configured to subject the sheets to moist air during cooling, while the sheets are flattened by being sucked against the substrate surface. In particular the apparatus may be provided with a more or less closed chamber encompassing at least the stabilization zone. The more or less closed chamber may be provided with moist air.

In this embodiment, sheets that may be over dried by a prior heat treatment are rehydrated while being flattened by being sucked against the substrate surface to such an extent that the moisture level in the sheets is comparable to the moisture level of sheets prior to the heat treatment. In this way, media deformation occurring after the cooling treatment in accordance with the present invention, due to moisture absorption in the sheets, is prevented or at least mitigated.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic view of a first embodiment of a treatment apparatus according to the present invention;

FIG. 2 is a schematic view of a second embodiment of a treatment apparatus according to the present invention;

FIG. 3 is a schematic view of a third embodiment of a treatment apparatus according to the present invention; and

FIG. 4 is a schematic view of a fourth embodiment of a treatment apparatus according to the present invention;

### DETAILED DESCRIPTION OF THE PREFERRED EMBODIMENTS

The present invention will now be described with reference to the accompanying drawings, wherein the same or similar elements are identified with the same reference numeral.

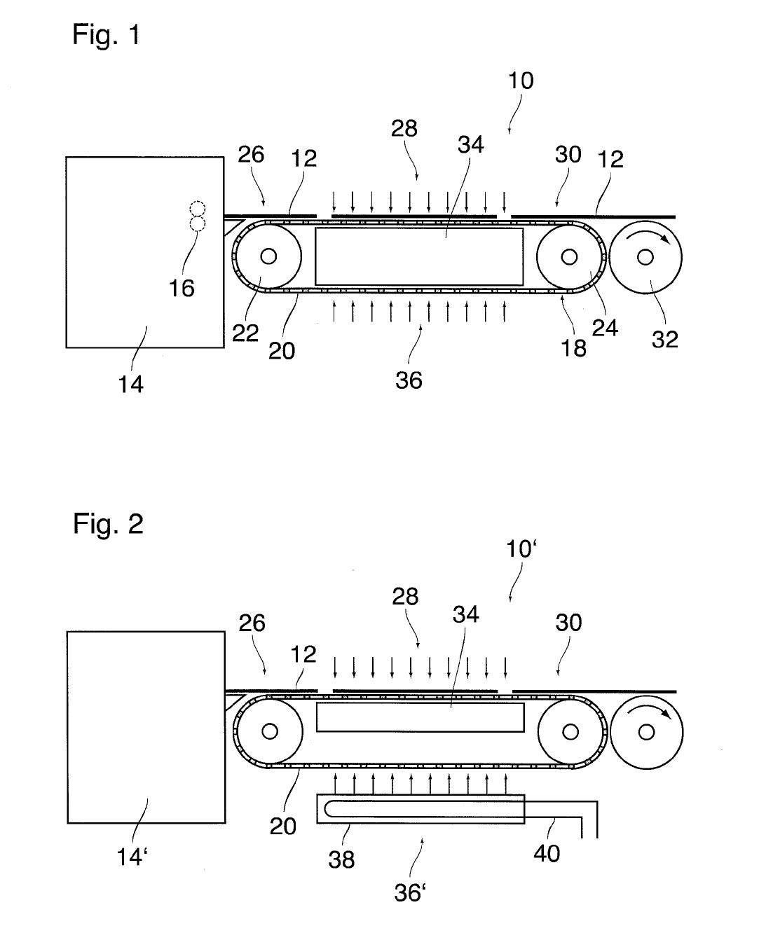

As is shown in FIG. 1, an apparatus 10 for treating media sheets 12 is disposed on a discharge side of an image forming apparatus 14, such as a printer or copier in which images are applied to the media sheets. In the example shown in FIG. 1, the image forming apparatus 14 comprises a fuse station 16 where the sheets 12 are passed through a nip between heated rollers so as to heat the sheets in order to fuse the images formed thereon. Consequently, the sheets 12 have an elevated temperature when they are transferred onto the treatment apparatus 10.

In the example shown in FIG. 1, the apparatus 10 comprises a conveyer 18 with a perforated conveying and support substrate 20 in the form of an endless belt that is passed around rollers 22, 24.

The sheets 12 discharged from the image forming apparatus 14 enter into the treatment apparatus 10 on an entry side 26 of a stabilization zone 28 and are conveyed on a top section of the substrate 20 through the stabilization zone 28 to an exit side 30 thereof, where the sheets are passed on via a discharge roller 32.

A suction box 34 is disposed underneath the top section of the substrate 20 in the stabilization zone 28 and applies a vacuum to the perforations of the substrate 20, so that the sheet 12 is forcefully sucked against the flat surface of the substrate 20, as indicated by arrows in FIG. 1.

The substrate 20 is made of a material, e. g., a metal, having a high heat capacity and a high thermal conductivity, so that the heated sheets 12 that are held in close contact with the substrate 20 by the action of the suction box 34 transfer most of their heat to the substrate 20 and are thereby cooled down to approximately ambient temperature. The combined effect of cooling the sheets 12 and simultaneously sucking them against the flat surface of the substrate 20 stabilizes the sheets 12 in a flat state and prevents the sheets from deforming, not only when they are held on the substrate 20 but also when they have left the treatment apparatus 10.

The endless belt forming the substrate 20, which has been heated through thermal contact with the sheets 12 in the stabilization zone 28, returns from the exit side 30 to the entry side 26 of the stabilization zone on the bottom side of the conveyer 18 and, on its return path, is cooled by means of a cooling system 36. As a result, when the substrate 20 reaches the entry side 26 again, its temperature has been restored to approximately ambient temperature, so that the substrate is ready again to absorb heat from the sheets 12. Thus, the substrate 20 serves as a heat transfer medium permitting cooling of the sheets 12 indirectly by means of the cooling system 36.

In the example shown in FIG. 1, the cooling system 36 is formed by a portion of the suction box 34 that has suction openings not only on the top side but also on the bottom side, so that ambient air is sucked in through the perforations of the bottom section of the substrate 20, as also indicated by arrows in FIG. 1. Whereas the perforations of the substrate 20 in the stabilization zone 28 are blocked by the overlying sheets 12, so that the suction box has no substantial cooling effect, the perforations in the bottom section of the substrate 20 are open, so that ambient air passes through these perforations into the suction box, with the result that the substrate 20 is efficiently cooled down to ambient temperature.

FIG. 2 shows a treatment apparatus 10′ according to a modified embodiment, which differs from the apparatus 10 in that a different type of cooling system 36′ is employed. In this case, the suction box 34 has suction openings only on the top side facing the stabilization zone 28, whereas the bottom of the suction box is spaced apart from the lower section of the substrate 20. The cooling system 36′ comprises a blower 38 and a heat exchange pipe 40 that is used for circulating a refrigerant through the blower 38 so that air that is blown out by the blower is cooled to a temperature below ambient temperature. The cold air is blown against the substrate 20 and passes through the perforations thereof, so that the substrate 20 is also cooled to a temperature below ambient temperature, resulting in an enhanced cooling effect on the sheets 12 that are conveyed through the stabilization zone 28. This treatment apparatus 10′ may therefore be useful even in conjunction with an image forming apparatus 14′ that employs an image forming process in which the sheets 12 are not subjected to a heat treatment, so that the sheets leave the image forming apparatus 14′ at approximately ambient temperature.

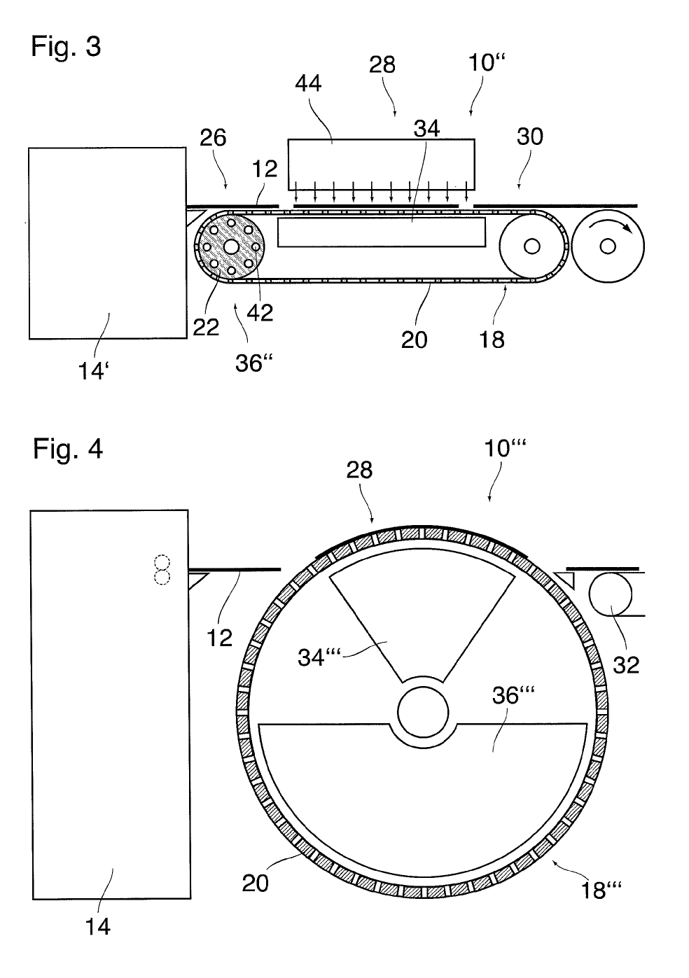

FIG. 3 illustrates an embodiment of a treatment apparatus 10″, wherein a cooling system 36″ is integrated in one of the rollers 22 of the conveyer 18, preferably the roller 22 on the entry side 26. This roller 22 has a massive body made of a material with good heat conductivity, e.g. a metal, and includes a number of coolant passages 42 for circulating a refrigerant. The roller 22 is thereby cooled to a temperature below ambient temperature, and the substrate 20 is cooled by thermal contact with the roller 22.

In an alternative embodiment (not shown) the top surface of the suction box 34 may be cooled with a refrigerant.

A humidifier 44 is disposed above the sheet 12 in the stabilization zone 28 for increasing the moisture content of the air that is blown or drawn against the sheet, thereby to re-humidify the sheet while it is being flattened.

FIG. 4 illustrates an embodiment of a treatment apparatus 10′″ wherein the perforated substrate 20 forms the peripheral surface of a drum-type conveyer 18′″. A suction box 34′″ is disposed in the top part of the drum conveyer, and a cooling system 36′″ that may be configured analogous to any of the cooling systems 36 and 36′ shown in FIGS. 1 and 2 is disposed in the bottom part of the drum conveyer. Alternatively, the suction box 34′″ may be cooled.

The sheets 12 discharged from the image forming apparatus 14 are sucked against the surface of the substrate 20 and conveyed through the stabilization zone 28 until they are separated from the conveyer at the discharge roller 32. Since the diameter of the drum-type conveyer 18′″ is large in comparison to the size of the sheets 12, a curvature that may be imposed on the sheets 12 in the stabilization zone 28 is so low that it is negligible in the subsequent handling of the sheets.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A system, comprising:
an image forming apparatus comprising a processing stage configured to cause media sheets to be heated; and
an apparatus for treating media sheets after an image has been formed on the media sheets by the image forming apparatus, the apparatus for treating media sheets being disposed on a discharge side of the image forming apparatus and comprising:
a perforated conveying and support substrate arranged to convey the media sheets through a stabilization zone where the conveying and support substrate has a limited curvature;
a suction device configured to apply a vacuum to the perforations of the conveying and support substrate in the stabilization zone so as to suck the media sheets against the conveying and support substrate; and
a cooling system arranged for actively cooling the media sheets while the media sheets are sucked against the conveying and support substrate in the stabilization zone.

2. The system according to claim 1, wherein the stabilization zone includes an entry side and an exit side, the conveying and support substrate forms part of an endless conveyer, the cooling system is arranged to cool the conveying and support substrate in a return path from the exit side to the entry side, and the media sheets are cooled by thermal contact with the cooled conveying and support substrate.

3. The system according to claim 2, wherein the cooling system is formed by a suction box arranged to suck air through the perforations of the conveying and support substrate.

4. The system according to claim 2, wherein the cooling system comprises a blower arranged for blowing cold air against the conveying and support substrate.

5. The system according to claim 1, wherein the conveying and support substrate is an endless belt.

6. The system according to claim 2, wherein the conveying and support substrate is an endless belt, and the cooling system is integrated in a roller arranged to be in thermal contact with the conveying and support substrate.

7. The system according to claim 1, wherein the conveying and support substrate forms the surface of a rotating drum.

8. The system according to claim 1, wherein the apparatus further comprises a mechanism configured to subject the media sheets to moist air during cooling, while the media sheets are flattened by being sucked against a surface of the conveying and support substrate.

9. A method of treating media sheets, comprising the steps of
forming an image on the media sheets by a process that includes heating of the media sheets;
conveying the media sheets on a perforated conveying and support substrate through a stabilization zone, where the conveying and support substrate has a limited curvature;
applying a vacuum to the perforations of the conveying and support substrate in the stabilization zone so as to suck the media sheets against the conveying and support substrate; and
actively cooling the media sheets while they are sucked against the conveying and support substrate in the stabilization zone.

10. The method according to claim 9, wherein the conveying and support substrate forms part of an endless conveyer on which the media sheets are conveyed from an entry side to an exit side of the stabilization zone, the conveying and support substrate is cooled in a return path from the exit side to the entry side, and the media sheets are cooled by thermal contact with the cooled conveying and support substrate.

11. The method according to claim 9, further comprising the step of subjecting the media sheets to moist air during cooling, while the media sheets are flattened by being sucked against a surface of the conveying and support substrate.
